(19) United States
(12) Patent Application Publication
(10) Pub. No.: US 2015/0082191 A1
(43) Pub. Date: Mar. 19, 2015

(54) METHOD AND SYSTEM FOR SELECTIVELY CONTROLLING PARTICIPATION IN A MESSAGE CONVERSATION

(71) Applicant: OpenPeak Inc., Boca Raton, FL (US)

(72) Inventor: Carsten Michael Dietz, Boynton Beach, FL (US)

(21) Appl. No.: 14/308,259

(22) Filed: Jun. 18, 2014

Related U.S. Application Data
(60) Provisional application No. 61/836,774, filed on Jun. 19, 2013.

(51) Int. Cl. H04L 12/58; G06F 3/0484; G06F 3/01

(52) U.S. Cl. CPC H04L 51/12; H04L 51/16; G06F 3/016; G06F 3/04842
USPC 715/752; 709/206

(57) ABSTRACT

A method for selectively controlling participation in a message conversation is described herein. The method can include the step of sending an initial message that includes a first participant in which the first participant is one of several participants that are part of the initial message. The method can also include the step of receiving a silence command that is configured to restrict one or more characteristics associated with future messages that are related to the initial message. The silence command can identify the characteristics to be restricted and may be on behalf of the first participant. In response to the receipt of the silence command, a future message rule can be generated that is configured to apply the characteristic restrictions identified by the silence command to future messages that are related to the initial message. In addition, future messages that are related to the initial message may be detected for purposes of executing the future message rule for application of the characteristic restrictions identified by the silence command.

### CROSS-REFERENCE TO RELATED APPLICATIONS

This patent application claims priority to U.S. Patent Provisional Application No. 61/836,774, filed on Jun. 19, 2013, which is incorporated herein by reference in its entirety.

### FIELD OF TECHNOLOGY

The present description relates to systems and methods for message participation, such as message threads, and more particularly, for selectively controlling participation in such messages.

### BACKGROUND

Most employees communicate with one another through some type of electronic communications, like email, SMS/MMS or instant messaging. In most of these environments, three or more individuals may be involved in the communication. That is, many of these exchanges involve a relatively large number of individuals, which can generate an excessive (and overwhelming) number of responses. For example, it is common for an email thread to include the sender, one or more recipients and one or more other individuals listed as carbon copy (cc) recipients. As is known, each of these individuals have the capability of generating replies to the thread, and the conversation may evolve to a different topic, one that does not concern some of the original recipients. Nevertheless, these original recipients who are no longer relevant to the thread will continue to be bombarded with the replies from those still engaged in the thread.

### SUMMARY

A method for selectively controlling participation in a message conversation is described herein. The method can include the step of sending an initial message that includes a first participant in which the first participant is one of several participants that are part of the initial message. The method can also include the step of receiving a silence command that can be configured to restrict one or more characteristics associated with future messages that are related to the initial message in which the silence command identifies the characteristics to be restricted and is on behalf of the first participant. In response to the receipt of the silence command, a future message rule can be generated, and the future message rule can be configured to apply the characteristic restrictions identified by the silence command to future messages that are related to the initial message. The method can also include the step of detecting future messages that are related to the initial message for purposes of executing the future message rule for application of the characteristic restrictions identified by the silence command.

As an example, the characteristics to be restricted include an audible notification associated with the receipt of a future message related to the initial message, a visual notification associated with the receipt of a future message related to the initial message or a tactile notification associated with the receipt of a future message related to the initial message. As another example, the characteristic restrictions are configured to cause removal of at least a portion of the text or images of a future message related to the initial message or a complete block of a future message related to the initial message.

The method can also include the step of storing the portion of the text or images related to the initial message that was removed or the future message related to the initial message that was blocked. Alternatively, the portion of the text or images related to the initial message that was removed or the future message related to the initial message that was blocked can be deleted. If the content was stored, access can be permitted to the stored portion of the text or images related to the initial message that was removed or the stored future message related to the initial message that was blocked. In another example, the silence command can be further configured to restrict the characteristics associated with future messages from only a portion of the participants that are related to the initial message.

In one embodiment, detecting the future messages includes detecting the future messages that are related to the initial message for purposes of executing the future message rule by one or more processes. Examples of these processes include (1) comparing information in a field of the future messages to information in a corresponding field of the initial message; (2) comparing a conversation identification associated with the future messages to a conversation identification associated with the initial message; or (3) comparing the participants of the future messages to the participants of the initial message.

Another method for selectively controlling participation in a message conversation is described herein. As an example, the message conversation can be an email exchange. This method can include the step of receiving an initial message that includes a first participant in which the first participant is one of several participants that are part of the initial message. At least some of the participants are able to generate a future message in relation to the initial message. The method can also include the step of receiving a silence command that can be configured to restrict one or more characteristics associated with future messages in relation to the initial message. In particular, the silence command may identify the characteristics of the future messages to be restricted and is on behalf of the first participant. In addition, a silence notification can be transmitted to a message server. The silence notification can be configured to cause the message server to apply a future message rule against the future messages related to the initial message such that the characteristic restrictions are enforced against the future messages related to the initial message.

Examples of the characteristic restrictions that are enforced against the future messages include the blocking of an audio notification, a visual notification or a tactile notification. In one particular example, the visual notification can be a badge value, and the blocking of the visual notification can include blocking the badge value from being incremented when a future message is received. As another example, the tactile notification can be a vibration, and the blocking of the tactile notification can include blocking the vibration when a future message is received.

In another arrangement, the characteristic restrictions that are enforced against the future messages can include blocking the delivery of the future messages or removing content from the future messages. As another example, the characteristic restrictions are only enforced against some of the participants of the message conversation.

In one embodiment, the method can further include receiving a deactivation command in which one more events may cause the receipt of the deactivation command. Examples of these events include one or more of the following: (1) a selection of a deactivation command option; (2) a passage of a predetermined amount of time; or (3) a reply message from the first participant in relation to the initial message or a future message.

A message management system is also described herein. The system can include an interface that is configured to send an initial message that includes a first participant. The first participant may be one of several participants that are part of the initial message. The interface may also be configured to receive a silence command that is intended to restrict one or more characteristics associated with future messages that are related to the initial message and that identifies the characteristics to be restricted and is on behalf of the first participant. The system can also include a message management engine that may be configured to apply a future message rule against the future messages that are related to the initial message. The application of the future message rule may be in response to the receipt of the silence command. In addition, the message management engine can be further configured to detect the future messages that are related to the initial message for application of the future message rule.

The system may also include a database. In this case, the message management engine can be further configured to store in the database future messages that have been affected by the application of the future message rule. As an example, the message management engine can be further configured to enable access to the future messages that are stored in the database. In some cases, the access to the future messages that are stored in the database can be provided to the first participant.

In one embodiment, the message management engine is further configured to receive a deactivation command. The deactivation command can be used to remove the silence command and the application of the future message rule.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system for selectively controlling participation in a message conversation.

FIG. 2 illustrates an example of a method for selectively controlling participation in a message conversation.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described. The term “among,” as it is used throughout this description, should not necessarily be interpreted as requiring data exchanges among three or more unrelated applications, devices or participants, irrespective of grammar rules.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The terms “computer program medium” and “computer readable medium” are defined as one or more components that are configured to store instructions that are to be executed by a processing unit.

An “application” is defined as a program or programs that perform one or more particular tasks on a computing device. Examples of an application include programs that may present a user interface for interaction with a user or that may run in the background of an operating environment that may not present a user interface while in the background. The term “operating system” is defined as a collection of software components that directs a computing device's operations, including controlling and scheduling the execution of other programs and managing storage, input/output and communication resources. A “processing unit” is defined as one or more components that execute sets of instructions, and the components may be disparate parts or part of a whole unit and may not necessarily be located in the same physical location. Examples of a processing unit are a central processing unit (CPU) and a controller.

The terms “database,” “memory” or “memory element” are defined as one or more components that are configured to store data, either on a temporary or persistent basis. An “interface” is defined as a component or a group of components that enable(s) a device to communicate with one or more different devices, whether through hard-wired connections, wireless connections or a combination of both. A “transceiver” is defined as a component or a group of components that transmit signals, receive signals or transmit and receive signals, whether wirelessly or through a hard-wired connection or both. A “message management engine” is defined as a combination of hardware and software components that are configured to manage the delivery of messages to and/or from a computing device.

The term “initial message” is defined as an electronic message that begins an electronic message exchange between or among several individuals or devices. A “participant” is defined as an individual or device that generates or consumes electronic messages. A “silence command” is a command that is configured to restrict one or more notification characteristics of an electronic message or the delivery of the message (or at least some portion of that message) to an intended recipient. A “future message” is defined as a message that is related to an initial message and occurs after the delivery of the initial message such that the future message would possibly create a distraction in the future for a participant of the initial message. An “audible notification” is defined as a notification that is designed to notify someone or something of an event through generation of a sound. A “visual notification” is defined as a notification that is designed to notify someone or something of an event through generation of a visual element. A “tactile notification” is defined as a notification that is designed to notify someone or something of an event through generation of a tactile signal. The term “future message rule” is defined as instructions, directives or commands for the processing or management of future messages.

As explained earlier, it is common for individuals, through the use of their mobile devices or other computing devices, to conduct communications through the generation and receipt of messages, such as emails. Unfortunately, it is easy for an initial message with several participants to lead to numerous replies and interruptions and to create a lengthy and unmanageable thread.

To overcome this issue, a method and system for selectively controlling participation in a message conversation is described herein. The method can include the step of sending an initial message that includes a first participant in which the first participant is one of several participants that are part of the initial message. The method can also include the step of receiving a silence command that is configured to restrict one or more characteristics associated with future messages that are related to the initial message. The silence command can identify the characteristics to be restricted and may be on behalf of the first participant. In response to the receipt of the silence command, a future message rule can be generated that is configured to apply the characteristic restrictions identified by the silence command to future messages that are related to the initial message. In addition, future messages that are related to the initial message may be detected for purposes of executing the future message rule for application of the characteristic restrictions identified by the silence command. The characteristics that may be restricted are numerous, and examples include audio, video and tactile notifications and even outright blocking of messages.

As such, a user may determine that his/her participation in a message exchange is no longer required, and the user can take steps to minimize or eliminate that participation. This feature can prevent unnecessary messages from building up on the user's computing device or at least can eliminate distractions associated with the notifications that typically accompany them.

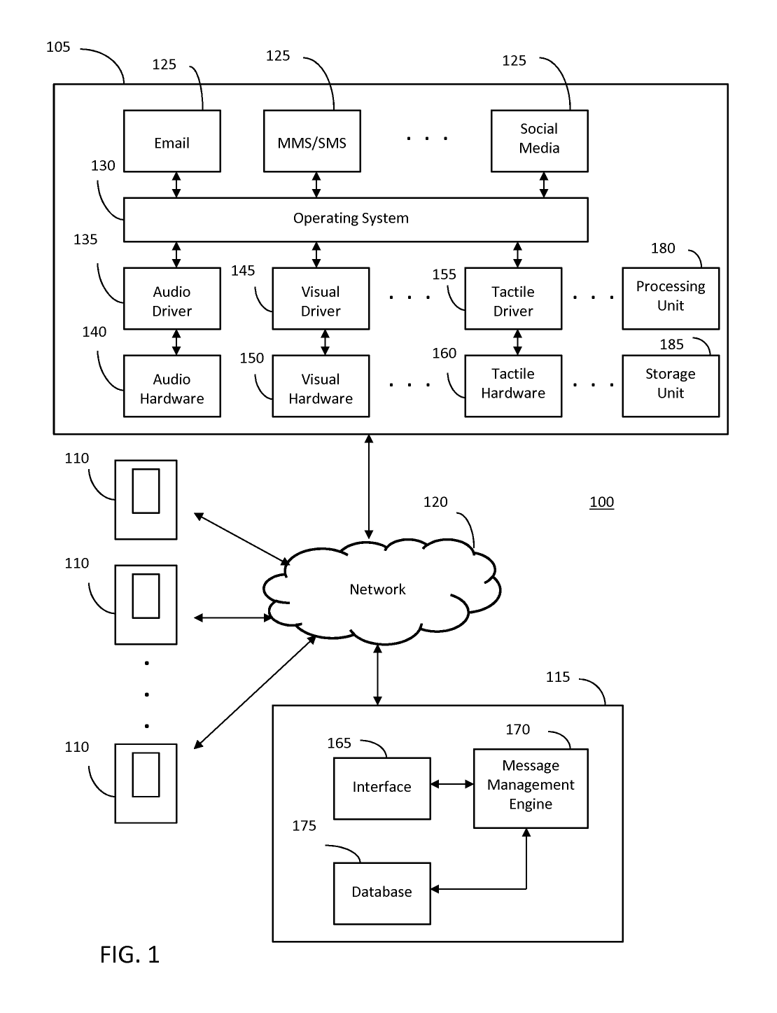

Referring to FIG. 1, a system 100 for selectively controlling participation in a message conversation is shown. In one arrangement, the system 100 can include a computing device 105 that is capable of exchanging messages with one or more other computing devices 110. The computing devices 105, 110 may be portable or fixed devices that can be configured to exchange a wide variety of messages with one another. The system 100 may also include a message server 115 to manage and otherwise facilitate the message exchange between the computing devices 105. One or more networks 120 may also be part of the system 100 to enable the computing devices 105 to communicate with one another and the message server 115. To be sure, the network 120 can be any suitable combination of networks and communication devices to enable such communications, including local or wide area and wired or wireless communications.

The computing device 105 may include several messaging applications 125, such as an email application, an MMS/SMS application and a social media application. Although several examples of messaging applications are shown in FIG. 1, it must be noted that the principles described herein may apply to any application that enables two or more individuals to exchange messages with one another, whether it be through text, images or voice. The computing device 105 may also include an operating system 130 and/or abstraction layers, which may facilitate the operation of the messaging applications 125 and may enable interactions between the applications 125 and other sub-layers and hardware components of the device 105. In another arrangement, the computing device 105 may also include several user interface (UI) elements, which can enable sensory-type information to be relayed to a user of the device 105. For example, the computing device 105 can include an audio driver 135 and audio hardware 140, a visual driver 145 and visual hardware 150 and a tactile driver 155 and tactile hardware 160.

Examples of audio hardware 140 may include speakers and structures/components for generating sounds to be broadcast over the speakers. For example, when a message is received by one of the messaging applications 125, any number and type of sounds may be conventionally generated and broadcast to the user by the audio hardware 140 to alert the user of such receipt. Examples of visual hardware may include a display unit and structures/components for producing visual elements to be displayed on the display unit. As an example, when a message is received by one of the messaging applications 125, the contents of the message may be displayed and some notification may be displayed to alert the user of the receipt of the message. One particular example of a relevant visual element is a badge that displays a value corresponding to the number of unread messages associated with a particular messaging application 125. Examples of tactile hardware 160 may include a vibration mechanism and supporting structure to enable a vibration to be generated to alert a user of the receipt of a message by one or more of the messaging applications 125. Other components may also serve as the tactile hardware 160 so long as they are able to generate sensory stimulation related to touch.

The computing device 105 may also include one or more processing units 180 and one or more storage units 185. The processing unit 180 can be configured to process silence commands that may be selectively initiated, for example, in response to the receipt of a message with respect to the operation of a messaging application 125. The storage unit(s) 185 can be used to store information related to the operation of the silence command, such as parameters that are related to the silence command or messages that may be restricted in some way in response to the initiation of the silence command.

The message server 115 may include an interface 165, a message management engine 170 and a database 175. The interface 165 can be configured to enable the message server to exchange messages with the computing devices 105 and other suitable components through the network 120. The message management engine 170 can include any suitable combination of software and hardware to manage the exchange of messages with the computing devices 105. In addition, the database 175 can store messages related to the computing devices 105. Although only one message server 115 is shown here, the system 100 may include any suitable number of such servers 115 for managing various messaging formats for any number of computing devices 105.

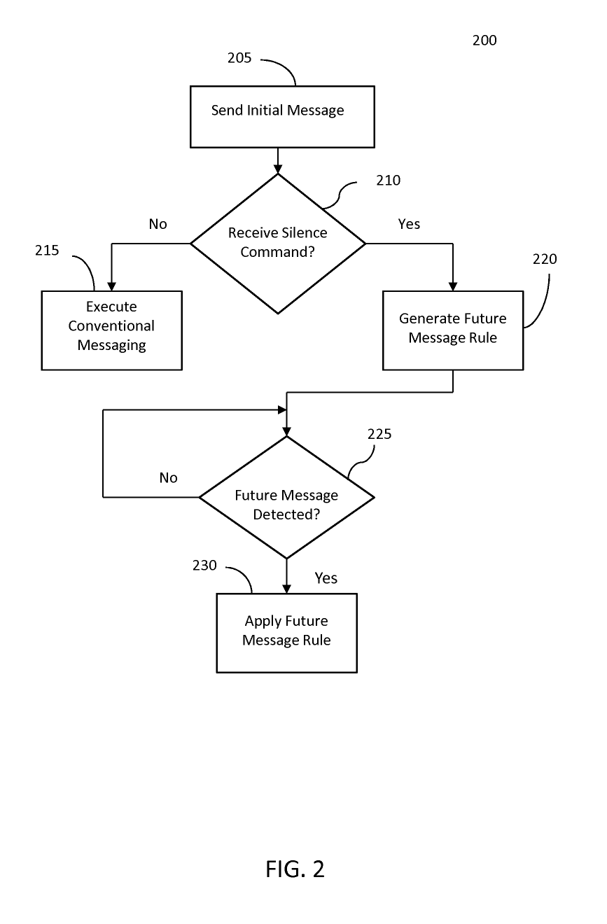

Referring to FIG. 2, a method 200 of selectively controlling participation in a message conversation is shown. It is important to note that the method 200 may include additional or even fewer steps or processes in comparison to what is illustrated in FIG. 2. Moreover, the method 200 is not necessarily limited to the chronological order that is shown in FIG. 2. In describing the method 200, reference may be made to FIG. 1, although it is understood that the method 200 may be practiced with any other suitable systems and components.

At step 205, an initial message can be sent, and at decision block 210, it can be determined whether a silence command has been received. If the silence command has not been received, then conventional messaging may be executed, as shown at step 215. If the silence command has been received, however, then a future message rule may be generated, as shown at step 220. At decision block 225, it can be determined whether a future message has been detected. If the future message is detected, then the future message rule may be applied, as shown at step 230. Examples of these steps will now be presented.

As an example, the message management engine 170 may receive a message that is intended for delivery to several participants, and these participants may carry computing devices 105. The message management engine 170 may then send the message to the computing devices 105 of the designated participants. For purposes of clarity, one of these participants may be referred to as a first participant, and this message may be referred to as an initial message.

The initial message may be received by the participants, and at least some of the participants may be able to generate a future message in response to the receipt of the initial message. Thus, any number of future messages related to the initial message may be exchanged among the participants of the conversation. As noted earlier, the receipt of these messages at the computing devices 105 may correspondingly cause the audio hardware 140, the visual hardware 150 and/or the tactile hardware 160 to take action to notify the participant.

At some point, a participant may determine that his/her participation in the message exchange is no longer required or the interruptions associated with such exchange should be minimized, including a complete blockage. For example, the first participant may decide that his participation is no longer necessary, and the first participant may trigger a silence command. The first participant can trigger the silence command by, for example, selecting a soft button on a display, a physical button on a keypad, or some other UI element of his computing device 105. In one arrangement, the UI element that triggers the silence command can be accessed and activated from the messaging application 125 itself, although the silence command can be initiated from any other suitable location or interface.

The silence command can be based on varying levels of message restriction, and a menu may be presented to the first participant to enable the first participant to make selections in regard to such levels. That is, the silence command can be used to restrict one or more characteristics associated with future messages that are related to the initial message. For example, the first participant may decide to block all future messages that are related to the initial message or just the content or of such messages or portions thereof, like the text or attachments associated with the messages. In another example, only the future messages that are from certain other participants may be blocked or otherwise restricted, thereby allowing only messages from select individuals (or addresses) to be received or otherwise normally processed.

In another example, the first participant may decide to restrict the notifications that are normally executed upon the receipt of a message. In particular, the first participant may block from being broadcast any sounds that would normally be played when a message is received. As another example, the first participant may block a badge value from being incremented or even displayed when a message is received. Other visual elements may also be blocked in this situation, like a light may be prevented from illuminating when the message is received. The first participant may also take steps to block any tactile notifications, like a vibration, from being executed when a message is received. These examples are non-limiting, as any number and type of notifications may be restricted.

The selections made by the first participant may be recorded, and the silence command, which may contain data related to these selections, can be sent from the computing device 105 of the first participant to the message server 115. In response to the receipt of the silence command, the message server 115 can acknowledge that the command is on behalf of the first participant and can generate a future message rule. This future message rule can be based on the data contained in the silence command and can be applied to future messages that are related to the initial message. By being related to the initial message, the future message can be a reply or some other communication continuation that builds on or otherwise supplements the initial message.

As an example, if the silence command indicates that the first participant wishes to block all future messages related to the initial message, then the message management engine 170 can generate a future message rule that establishes this policy. As such, any relevant future messages related to the initial message can be blocked from being sent to the computing device 105 of the first participant. In another example, the silence command may indicate that future messages from a certain other participant are to be blocked or that certain content from future messages is to be removed. If desired, the first participant may also block messages or set other restrictions on behalf of another participant. In either arrangement, the message management engine 170 can cause the relevant messages to be blocked or can take steps to cause the flagged content to be stripped from the future messages.

As noted earlier, the first participant may wish to block one or more notifications that typically accompany the receipt of a future message, on behalf of himself or another party. To carry out this selection, the future message rule can cause the relevant future messages associated with the initial message to be marked as read or otherwise as being acknowledged by the first participant. This feature may enable the future messages to be delivered to the computing device 105 of the first participant but may minimize or prevent the notifications from being activated and distracting the first participant.

If a future message is blocked or at least some content of a future message is prevented from being sent to the computing device 105 of the first participant, the message management engine 170 can move the blocked future message or the affected content to the database 175 for storage. If the first participant wishes to access this blocked material at a later date, the first participant may be allowed to retrieve it and have it delivered to his computing device 105 at that time. In another example, the blocked data can simply be deleted from the database 175.

In the examples described above, the future message rule is applied at the message server 115. This feature allows the selections that the first participant makes to apply to any computing device 105 that is associated with the first participant and that exchanges messages with the message server 115. Thus, the future message rule may control participation in a message conversation over multiple computing devices 105 that are associated with a particular participant.

It must be noted, however, that the restrictions placed on the future messages can be controlled at the computing device 105, as opposed to the message server 115. For example, the processing unit 180 of the computing device 105 can be configured to generate the future message rule and can take action similar to that of the message server 115, like marking messages as read to avoid notifications. If a future message or some of its content is to be blocked, the processing unit 180 can be configured to move the message or the content to a special folder, where it can be accessed later, or it can simply be deleted from the device 105. The storage unit 185 of the computing device 105 can store the special folder, or the folder can be stored remotely.

As noted earlier, the future messages that are affected in accordance with the examples thus far presented may be related to the initial message. As such, steps can be taken to ensure accurate application of the future message rule. In one embodiment, the future messages may be identified by recording the text in the subject line of the initial message (or some other suitable field) when the silence command is received and comparing this text to that of the future messages in the respective field(s). Of course, text or other information that forms other parts of the initial message may be used for discriminatory purposes. In another embodiment, a conversation ID associated with an initial message of a message exchange may be flagged, and this conversation ID may be compared to the future messages to determine if the future messages are related to the initial message. As another example, the participants of the initial message may be recorded, and this information may be used to identify relevant future messages. In fact, virtually any technique for identifying future messages that are related to the initial message and that are to be affected by a future message rule may be employed here. Moreover, any previous message may serve as the initial message for purposes of comparing any suitable parameter to identify a future message that is associated with a particular message exchange.

At some point, the first participant may determine that it is no longer necessary to enforce the silence command. To do so, the first participant may simply make a selection that deactivates the silence command, and future messages may be conventionally processed (no blocking and no notification restrictions). As another option, the silence command may be revoked if any one or a combination of events is realized. For example, the silence command may be automatically removed after a predetermined amount of time or if the first participant deletes the messages related to the message conversation. As another example, the first participant may generate a reply to the initial message at a later time or a future message, and the silence command can be removed. The first participant may also log into a service that is associated with the management of the message exchange and can manually revoke the silence command. The removal of the silence command can be applied to the message server 115, the computing device 105 or both, depending on where the message rule is being applied.

While various embodiments have been described above, it should be understood that they have been presented by way of example only, and not limitation. It will be understood by those skilled in the relevant art(s) that various changes in form and details may be made therein without departing from the spirit and scope of the subject matter as defined in the appended claims. Accordingly, the breadth and scope of the claims should not be limited by any of the above-described exemplary embodiments.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method for selectively controlling participation in a message conversation, comprising:
sending an initial message that includes a first participant, wherein the first participant is one of several participants that are part of the initial message;
receiving a silence command that is configured to restrict one or more characteristics associated with future messages that are related to the initial message, wherein the silence command identifies the characteristics to be restricted and is on behalf of the first participant;
in response to the receipt of the silence command, generating a future message rule that is configured to apply the characteristic restrictions identified by the silence command to future messages that are related to the initial message; and
detecting future messages that are related to the initial message for purposes of executing the future message rule for application of the characteristic restrictions identified by the silence command.

2. The method according to claim 1, wherein the characteristics to be restricted include an audible notification associated with the receipt of a future message related to the initial message, a visual notification associated with the receipt of a future message related to the initial message or a tactile notification associated with the receipt of a future message related to the initial message;

3. The method according to claim 1, wherein the characteristic restrictions are configured to cause removal of at least a portion of the text or images of a future message related to the initial message or a complete block of a future message related to the initial message.

4. The method according to claim 3, further comprising:
storing the portion of the text or images related to the initial message that was removed or the future message related to the initial message that was blocked; or
deleting the portion of the text or images related to the initial message that was removed or the future message related to the initial message that was blocked.

5. The method according to claim 4, further comprising permitting access to the stored portion of the text or images related to the initial message that was removed or the stored future message related to the initial message that was blocked.

6. The method according to claim 1, wherein the silence command is further configured to restrict the characteristics associated with future messages from only a portion of the participants that are related to the initial message.

7. The method according to claim 1, wherein detecting the future messages comprises detecting the future messages that are related to the initial message for purposes of executing the future message rule by one or more of the following:
comparing information in a field of the future messages to information in a corresponding field of the initial message;
comparing a conversation identification associated with the future messages to a conversation identification associated with the initial message; or
comparing the participants of the future messages to the participants of the initial message.

8. A method for selectively controlling participation in a message conversation, comprising:
receiving an initial message that includes a first participant, wherein the first participant is one of several participants that are part of the initial message, and at least some of the participants are able to generate a future message in relation to the initial message;
receiving a silence command that is configured to restrict one or more characteristics associated with future messages in relation to the initial message, wherein the silence command identifies the characteristics of the future messages to be restricted and is on behalf of the first participant; and
transmitting a silence notification to a message server, wherein the silence notification is configured to cause the message server to apply a future message rule against the future messages related to the initial message such that the characteristic restrictions are enforced against the future messages related to the initial message.

9. The method according to claim 8, wherein the characteristic restrictions that are enforced against the future messages includes the blocking of an audio notification, a visual notification or a tactile notification.

10. The method according to claim 9, wherein the visual notification is a badge value and the blocking of the visual notification comprises blocking the badge value from being incremented when a future message is received.

11. The method according to claim 9, wherein the tactile notification is a vibration and the blocking of the tactile notification comprises blocking the vibration when a future message is received.

12. The method according to claim 8, wherein the characteristic restrictions that are enforced against the future messages includes blocking the delivery of the future messages or removing content from the future messages.

13. The method according to claim 8, wherein the characteristic restrictions are only enforced against some of the participants of the message conversation.

14. The method according to claim 8, further comprising receiving a deactivation command, wherein one or more of the following events causes the receipt of the deactivation command:
a selection of a deactivation command option;
a passage of a predetermined amount of time; or
a reply message from the first participant in relation to the initial message or a future message.

15. The method according to claim 8, wherein the message conversation is an email exchange.

16. A message management system, comprising:
an interface that is configured to send an initial message that includes a first participant, wherein the first participant is one of several participants that are part of the initial message and wherein the interface is also configured to receive a silence command that is intended to restrict one or more characteristics associated with future messages that are related to the initial message and that identifies the characteristics to be restricted and is on behalf of the first participant;
a message management engine that is configured to apply a future message rule against the future messages that are related to the initial message and the application of the future message rule is in response to the receipt of the silence command, wherein the message management engine is further configured to detect the future messages that are related to the initial message for application of the future message rule.

17. The message management system according to claim 16, further comprising a database, wherein the message management engine is further configured to store in the database future messages that have been affected by the application of the future message rule.

18. The message management system according to claim 17, wherein the message management engine is further configured to enable access to the future messages that are stored in the database.

19. The message management system according to claim 18, wherein the access to the future messages that are stored in the database is provided to the first participant.

20. The message management system according to claim 16, wherein the message management engine is further configured to receive a deactivation command to remove the silence command and the application of the future message rule.
